(19) United States
(12) Patent Application Publication
(10) Pub. No.: US 2005/0289028 A1
(43) Pub. Date: Dec. 29, 2005

(54) Method and apparatus for charging interest on law firm out-of-pocket expenses

(75) Inventor: Steven W. Lundberg, Edina, MN (US)

Correspondence Address: Schwegman, Lundberg, Woessner & Kluth, P.A., P.O. Box 2938, Minneapolis, MN, 55402, US

(73) Assignee: Patent and Trademark Fee Management, LLC

(21) Appl. No.: 11/145,818

(22) Filed: Jun. 6, 2005

Related U.S. Application Data
(60) Provisional application No. 60/577,650, filed on Jun. 7, 2004.

(51) Int. Cl. G06F 17/60

(52) U.S. Cl. 705/32

(57) ABSTRACT

This application discloses method and system in which a party independent of the law firm contracts with the law firm to reimburse the law firm for interest costs incurred on out-of-pocket expenses paid by the law firm. In one embodiment, a law firm incurs an out-of-pocket expense for a client, and contemporaneously with incurring the expense, the independent party assesses a fee to the law firm for the particular out-of-pocket expense. The fee is assessed, in one embodiment, according the amount of time the law firm is expected to carry the expense. The law firm bills the client for the expense and associated assessed fee as disbursements. The law firm receives payment by the client of the expense and the assessed fee, whereby the client reimburses the law firm for the expense and also reimburses the law firm for the assessed fee. The actual carry period for the expense is determined by calculating the time from the point the expenses was incurred/advanced by the firm until the time reimbursement for the expense was received. The assessed fee is paid to the independent party. The independent party pays the law firm an interest payment to reimburse the law firm for the actual cost of carrying the expense, such that the law firm is reimbursed only for an actual cost incurred in carrying the expense—the independent party reimburses the law firm for the interest cost incurred from the proceeds of the assessed fee.

### RELATED APPLICATIONS

The present application claims the benefit of priority under 35 U.S.C. § 119(e) of U.S. Provisional Application 60/577,650, filed Jun. 7, 2004, which is incorporated herein by reference.

### TECHNICAL FIELD OF THE INVENTION

This application pertains generally to accounting systems for attorneys, and more particularly to payment of out-of-pocket expenses by law firms for clients.

### BACKGROUND OF THE INVENTION

Law firms are routinely called upon to pay expenses for clients, or to assume the obligation to pay an expense for a client. Such expenses include, for example, payments to experts, payments to government agencies such as patent and trademark offices or regulatory agencies, payments to courts for filing fees, payments for travel expenses, or payments to co-counsel such as foreign patent and trademark attorneys. These expenses are typically incurred by the law firm as cash out-of-pocket expenses, for example when a firm pays an expense with a check or other negotiable instrument, or when the firm charges an expense for a client on the law firm's credit card or other credit account, such as a deposit account at a patent and trademark office. Such expenses can also come in the form of an obligation to pay an out-of-pocket expense. For example, by hiring an expert or other attorney on behalf of a client, the law firm often assumes the obligation to pay such an expert or attorney whether or not the client is able to pay the law firm when reimbursement is requested from the client by the law firm.

One problem for law firms is that these out-of-pocket expenses require substantial amount of capital. Such capital may be obtained by, for example, requiring shareholders or partners of the firm to contribute capital for this and other purposes, or by retaining earnings of the firm. The capital may also be obtained as a loan from a financing entity such as a bank or other lending sources.

Another challenge that law firms face are ethical restrictions on how they can charge for out-of-pocket expenses and other costs. Ethics typically require that a law firm cannot bill a client anything other than an actual cost incurred. In other words, a law firm cannot add a surcharge to a cost and then pass that along to the client as a so-called “disbursement.” For example, a law firm cannot add a 20% upcharge to the cost of meals or travel expenses and bill that to the client as a cost or expense. This means that law firms are not able to charge clients for interest unless and until the actual amount of the interest due is known. While a law firm may wish to charge interest on the capital it uses to pay out-of-pocket expenses, the law firm does not know how much interest it can properly charge until after the out-of-pocket expense is repaid by the client. At that point in time, however, it is undesirable for the law firm to send a second invoice to recover this interest cost due to the fact that the amount sought to be recovered it often small compared to the original invoice for services rendered in connection with the cost. Sending an invoice to recover such a small expense would be viewed negatively by the client, and also would most likely require a substantial amount of extra accounting labor for the law firm.

U.S. Pat. No. 6,363,361, entitled “COMPUTERIZED PATENT AND TRADEMARK FEE PAYMENT METHOD AND SYSTEM FOR LAW FIRMS”, and issued Mar. 26, 2002, describes methods and systems for, among other things, a party independent of the law firm charging the law firm an “up-front” financing fee to cover financing costs associated with a particular out-of-pocket expense incurred by the law firm. The law firm is able to pass this up-front charge along to the client with the bill seeking reimbursement for the out-of-pocket expense. Once the up-front charge is collected by the law firm, it is in turn paid to the independent party, who in turn can use proceeds from the charge to cover financing costs for the underlying out-of-pocket expense. This system allows the law firm to bill the client for financing costs such as interest, and do it up-front with the bill for the associated legal services, instead of seeking the reimbursement after the out-of-pocket fee is paid by the client.

### BRIEF DESCRIPTION OF THE DRAWING

FIG. 1 illustrates a system according to one example embodiment of the inventive subject matter disclosed herein.

### DETAILED DESCRIPTION OF THE INVENTIVE SUBJECT MATTER

In the following detailed description, reference is made to the accompanying drawing that forms a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the inventive subject matter disclosed herein. Therefore, the following detailed description is not to be taken in a limiting sense, and the scope of the inventive subject matter disclosed herein is defined by the appended claims and their equivalents.

The inventive subject matter described herein provides a method and system for reimbursing a law firm for interest costs incurred as a result of advancing the law firm's own capital to pay costs, for example out-of-pocket expenses, for clients. As noted above, such expenses include, for example, payments to experts, payments to government agencies such as patent and trademark offices or regulatory agencies, payments to courts for filing fees, payments for travel expenses, or payments to co-counsel such as foreign patent and trademark attorneys.

According to one example embodiment of the inventive subject matter, it was discovered that a law firm is entitled to charge a client a reasonable interest rate on law firm funds used to cover an out-of-pocket expense, without prior agreement by the client, in the same manner a law firm is entitled to charge a client for postage or photocopies or other such expenses. For example, if a law firm paid an expert for expert services rendered on behalf of a client in the amount of $5,000.00, and the $5,000.00 was carried by the law firm for 60 days prior to reimbursement by the client, then the law firm is entitled to charge the client a reasonable interest on the use of the $5,0000.00 on behalf of the client for 60 days. This interest represents a “cost incurred” for the client, as the funds required to carry the expense could otherwise be used by the law firm for other investments or to purchase equipment or any other such purpose. Charging interest for use of this law firm capital is in contrast with charging interest on a law firm invoice that is overdue. In such a case, the interest charged is not in relation to a cost incurred by the law firm, and therefore is subject to different ethical considerations.

As noted in the Background, however, a law firm may not charge for a cost incurred unless it knows what the cost is. It may not, for example, pre-charge for interest up-front that it does not know the actual amount of, unless the client expressly agrees to such a charge. Obtaining such an agreement from all clients concerned is not practical in most cases.

According to one example embodiment of the inventive subject matter, there is provided a method and apparatus that allows for charging a client for an interest cost up-front. According to this method and system, a party independent of the law firm contracts with the law firm to reimburse the law firm for interest costs incurred on out-of-pocket expenses paid by the law firm. The method and system, according to one example embodiment, operate as follows:
a law firm incurs an out-of-pocket expense for a client;
contemporaneously with incurring the expense, the independent party assesses a fee to the law firm specifically for the particular out-of-pocket expense;
the fee is assessed, in one embodiment, according the amount of time the law firm is expected to carry the expense for the particular client for which the expense was incurred—or the same carry period is used for all clients;
appropriate accounting entries are made to track the assessed fee;
the law firm bills the client for the expense and the associated assessed fee as disbursements, preferably in the same invoice or at least bills the client the assessed fee prior to reimbursement of the expense by the client (or alternatively only a portion of it);
the law firm receives payment by the client of the expense and the assessed fee, whereby the client reimburses the law firm for the expense and also reimburses the law firm for the assessed fee;
the actual carry period for the expense is determined by calculating the time from the point the expenses was incurred/advanced by the firm until the time reimbursement for the expense was received;
the assessed fee is paid to the independent party (in one example embodiment at a time subsequent to billing of the client for the assessed and preferably but not necessarily after the law firm normally would expect to be reimbursed for the expense);
the independent party pays the law firm an interest payment to reimburse the law firm for the actual cost of carrying the expense calculated as noted above, such that the law firm is reimbursed only for an actual cost incurred in carrying the expense—the independent party reimburses the law firm for the interest cost incurred from the proceeds of the assessed fee;
if the assessed fee exceeds the amount of interest cost actually incurred for carrying the expense, the independent party keeps the excess amounts, whereby the law firm does not obtain reimbursement for more than the actual carry cost;
according to one example embodiment, the carry period assumed for a particular client is adjusted from time to time so that the assessed fee for out-of-pocket expenses incurred for the client provide proceeds that match as closely as is possible the actual interest cost incurred for the typical expense advanced for that client—thus, clients that pay promptly will be assessed lower fees than those clients that typically take a long time to pay.

According to one example embodiment, the assessed fee has a first component that is intended to cover the actual interest cost incurred for the particular out-of-pocket expense, and a second component that is intended to compensate the independent party for its services in connection with supplying the software and/or services required to effectuate the described method and system. The first component can be determined by estimating the expected carry period for a particular expense and, using a reasonable interest rate, determining the expected interest cost incurred by the law firm. The second component can be a fixed charge, such as $5/per transaction, or it may be a percentage of the expense itself, such as 1.5%. For example, if the transaction was to cover a $1000.00 expense, the second component may be $15.00. Alternatively, the assessed fee may not include a second component, and the independent party could be rewarded for its services or software in another way. For example, the independent party may be paid a fixed monthly fee for providing its services by the law firm such that the cost of the service or software is incurred by the law firm and not the client. Or, the independent party may be paid by assessing a surcharge or premium on the reasonable interest rate used to determine the first component. For instance, if a reasonable interest rate was 5%, the first component may be determined using a 6% rate, and the extra 1% would result in excess proceeds assessed on each out-of-pocket expense that the independent party would keep after reimbursing the law firm for actual costs incurred. Or, the excess proceeds could be obtained by assuming a longer carry period than was expected. In any case, since the law firm is not obtaining reimbursement for anything other than its actual cost, it may receive such reimbursement ethically and without requiring prior agreement with the client.

According to yet another example embodiment, the method and system provides:
storing data regarding a plurality of law firm clients in a database;
designating at least some of those clients to be billed for interest incurred financing out-of-pocket expenses;
the law firm financing an out-of-pocket expense using law firm capital or a loan from a financing source;
the law firm billing a client for a particular financed out-of-pocket expenses;
an independent party (independent of the law firm) billing the law firm a financing fee associated with the financed out-of-pocket expense;
the law firm billing the client for at least a portion of the financing fee as a disbursement at the same time as billing the client for the associated out-of-pocket expense;
the client paying the law firm for the financed out-of-pocket expense and for the financing fee disbursed to the client;
determining how long the out-of-pocket expense was financed for based on when the law firm was paid by the client and when the out-of-pocket expense was incurred, and determining an actual financing cost incurred by the law firm as a result of financing the out-of-pocket cost for the client; and
the independent party reimbursing the law firm for the actual financing cost incurred by the law firm using at least in part proceeds from the financing fee billed to the law firm.

According to another example embodiment, the method and system further includes establishing a maximum amount that will be reimbursed to the law firm based on the financing fee such that the liability of the independent party to the law firm for a reimbursement does not exceed an amount billed to the law firm.

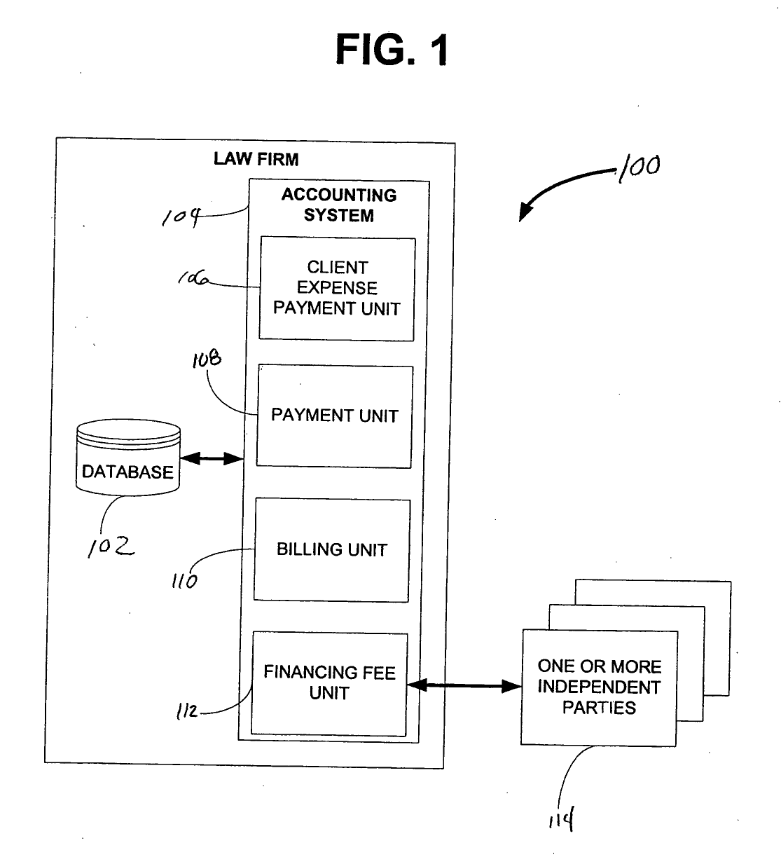

According to another example embodiment illustrated in FIG. 1, there is provided a system 100—including:
a database 102 retaining data on a plurality of law firm clients, where at least some of those clients are designated to be billed for interest incurred financing out-of-pocket expenses;
an accounting system 104 for the law firm adapted to pay an out-of-pocket expense for a client 106, wherein the out-of-pocket expense is paid using law firm capital or a loan from a financing source;
the accounting system 104 for the law firm further adapted to bill a client for a particular financed out-of-pocket expenses 110;
the accounting system 104 further adapted to process a financing fee associated with the financed out-of-pocket expense 112, wherein the financing fee is assessed by an independent party 114 (independent of the law firm);
the accounting system 104 for the law firm adapted to bill the client for at least a portion of the financing fee as a disbursement at the same time as billing the client for the associated out-of-pocket expense 110;
the accounting system 104 adapted to post a payment 108 from a client paying the law firm for the financed out-of-pocket expense and for the financing fee disbursed to the client;
the accounting system 104 or another system adapted to determine how long the out-of-pocket expense was financed for based on when the law firm was paid by the client and when the out-of-pocket expense was incurred 112, and determine an actual financing cost incurred by the law firm as a result of financing the out-of-pocket cost for the client 112, so that the independent party 114 can reimburse the law firm for the actual financing cost incurred by the law firm using at least in part proceeds from the financing fee billed to the law firm.

According to another example embodiment, the system further includes the accounting system or another system storing a maximum amount that will be reimbursed to the law firm based on the financing fee such that the liability of the independent party to the law firm for a reimbursement does not exceed an amount billed to the law firm.

According to still another example embodiment of the method or system described above, the system may be implemented at least in part within or closely integrated with a law firm accounting system.

According to still another example embodiment, the law firm may use its own capital to pay for out-of-pocket expenses advanced for clients, or it may use a combination of its own capital and a loan from a financing entity such as a bank. Or, in another alternative, the law firm may use a loan from a financing entity to cover the expenses in their entirety. In any variation, the actual cost incurred in interest is determined and reimbursed to the client.

In yet another example embodiment, the assessed fee may be too small to cover the entire interest cost incurred by the law firm. In such a case, the law firm may be reimbursed only for as much interest as the assessed fee was expected to covered. For instance, if the first component of the assessed fee was calculated to cover an expense for 60 days, and the actual carry was 90 days, only 60 days of carry would be reimbursed to the law firm.

1. A method, comprising:
storing data regarding a plurality of law firm clients in a database;
designating at least some of those clients to be billed for interest incurred financing out-of-pocket expenses;
the law firm financing an out-of-pocket expense using law firm capital or a loan from a financing source;
the law firm billing a client for a particular financed out-of-pocket expenses;
an independent party (independent of the law firm) billing the law firm a financing fee associated with the financed out-of-pocket expense;
the law firm billing the client for at least a portion of the financing fee as a disbursement at the same time as billing the client for the associated out-of-pocket expense;
the client paying the law firm for the financed out-of-pocket expense and for the financing fee disbursed to the client;
determining how long the out-of-pocket expense was financed for based on when the law firm was paid by the client and when the out-of-pocket expense was incurred, and determining an actual financing cost incurred by the law firm as a result of financing the out-of-pocket cost for the client; and
the independent party reimbursing the law firm for the actual financing cost incurred by the law firm using at least in part proceeds from the financing fee billed to the law firm.

2. The method of claim 1, further including establishing a maximum amount that will be reimbursed to the law firm based on the financing fee such that the liability of the independent party to the law firm for a reimbursement does not exceed an amount billed to the law firm.

3. The method of claim 1, wherein the at least a portion of the financing fee is determined as a function of an assumed carry period of the associated out-of-pocket expense.

4. The method of claim 3, wherein the assumed carry period is an estimated expected carry period.

5. The method of claim 1, wherein the financing fee includes a fixed-fee portion.

6. The method of claim 5, wherein the fixed-fee portion is a transaction fee.

7. The method of claim 1, wherein the financing fee includes a variable-fee portion.

8. The method of claim 7, wherein the variable fee portion is a percentage of the associated out-of-pocket expenses.

9. A system, comprising:
a database retaining data on a plurality of law firm clients, where at least some of those clients are designated to be billed for interest incurred financing out-of-pocket expenses;
an accounting system for the law firm adapted to pay an out-of-pocket expense for a client, wherein the out-of-pocket expense is paid using law firm capital or a loan from a financing source;
the accounting system for the law firm further adapted to bill a client for a particular financed out-of-pocket expenses;
the accounting system further adapted to process a financing fee associated with the financed out-of-pocket expense, wherein the financing fee is assessed by an independent party (independent of the law firm);
the accounting system for the law firm adapted to bill the client for at least a portion of the financing fee as a disbursement at the same time as billing the client for the associated out-of-pocket expense;
the accounting system adapted to post a payment from a client paying the law firm for the financed out-of-pocket expense and for the financing fee disbursed to the client;
the accounting system or another system adapted to determine how long the out-of-pocket expense was financed for based on when the law firm was paid by the client and when the out-of-pocket expense was incurred, and determine an actual financing cost incurred by the law firm as a result of financing the out-of-pocket cost for the client, so that the independent party can reimburse the law firm for the actual financing cost incurred by the law firm using at least in part proceeds from the financing fee billed to the law firm.

10. The system of claim 9, further including the accounting system or another system storing a maximum amount that will be reimbursed to the law firm based on the financing fee such that the liability of the independent party to the law firm for a reimbursement does not exceed an amount billed to the law firm.

11. The system of claim 9, wherein an amount the client is billed for the portion of the financing fee is determined by the accounting system as a function of an assumed carry period of the associated out-of-pocket expense.

12. The system of claim 11, wherein the assumed carry period is an estimated expected carry period.

13. The system of claim 9, wherein the financing fee includes a fixed-fee portion.

14. The system of claim 13, wherein the fixed-fee portion is a transaction fee.

15. The system of claim 9, wherein the financing fee includes a variable-fee portion.

16. The system of claim 15, wherein the variable-fee portion is a percentage of the associated out-of-pocket expense.
